(19) United States
(12) Patent Application Publication
(10) Pub. No.: US 2026/0150096 A1
(43) Pub. Date: May 28, 2026

(54) POWER EFFICIENT SCHEDULING FOR MULTICAST AND UNICAST COMMUNICATIONS

(71) Applicant: QUALCOMM Incorporated, San Diego, CA (US)

(72) Inventors: Diana MAAMARI, San Diego, CA (US); Le LIU, San Jose, CA (US); Gabi SARKIS, San Diego, CA (US)

(21) Appl. No.: 18/959,564

(22) Filed: Nov. 25, 2024

(51) Int. Cl. H04W 72/12; H04W 72/0446; H04W 72/0453; H04W 72/231

(52) U.S. Cl. CPC H04W 72/12; H04W 72/0446; H04W 72/0453; H04W 72/231

(57) ABSTRACT

Methods, systems, and devices for wireless communications are described. A user equipment (UE) may communicate, during a first time period while a baseband of the UE is in a first baseband state, via a first set of time and frequency resources associated with unicast scheduling of the UE, where the first baseband state supports communications by the UE in accordance with a first throughput, at least a first processing timeline, or both. The UE may then receive control signaling that indicates a multicast scheduling and a second set of time and frequency resources. The UE may then communicate via the first and second set of time and frequency resources during a second time period using either the first baseband state or a second baseband state based on information included in the control signaling, where the second baseband state is associated with higher power consumption than the first baseband state.

### FIELD OF TECHNOLOGY

The following relates to wireless communications, including power efficient scheduling for multicast and unicast communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. A user equipment (UE) may support different power states such as high-power states and low-power (e.g., power efficient) states that the UE may implement based on different network scheduling types, latency requirements, and peak throughput. For example, the UE may switch from a low power state to a high power state to accommodate high throughput wideband scheduling, and may switch back to a low power state to support lower throughput traffic and narrowband scheduling. In some aspects, the UE may also support both unicast and multicast scheduling. In some cases, however, multicast communications may lack power efficient scheduling, which may increase power expenditure by the UE.

In some implementations, the network and the UE may support power efficient scheduling for multicast communications. For example, the network may indicate, via control signaling, relaxed feedback processing timelines for multicast scheduling, reduced peak throughput, or presence of time domain gaps between scheduled downlink transmissions for multicast, which may allow the UE to remain in a power efficient mode while supporting multicast communications.

A method for wireless communications by a UE is described. The method may include receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, receiving, during a first time period, one or more first unicast shared channel messages via the first set of time and frequency resources and in accordance with the first scheduling configuration, receiving second control information associated with multicast scheduling of the UE via a second set of time and frequency resources, and receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

A UE for wireless communications is described. The UE may include one or more memories storing processor executable code, and one or more processors coupled with the one or more memories. The one or more processors may individually or collectively be operable to execute the code to cause the UE to receive first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, receive, during a first time period, one or more first unicast shared channel messages via the first set of time and frequency resources and in accordance with the first scheduling configuration, receive second control information associated with multicast scheduling of the UE via a second set of time and frequency resources, and receive, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

Another UE for wireless communications is described. The UE may include means for receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, means for receiving, during a first time period, one or more first unicast shared channel messages via the first set of time and frequency resources and in accordance with the first scheduling configuration, means for receiving second control information associated with multicast scheduling of the UE via a second set of time and frequency resources, and means for receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

A non-transitory computer-readable medium storing code for wireless communications is described. The code may include instructions executable by one or more processors to receive first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, receive, during a first time period, one or more first unicast shared channel messages via the first set of time and frequency resources and in accordance with the first scheduling configuration, receive second control information associated with multicast scheduling of the UE via a second set of time and frequency resources, and receive, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

In some examples of the method, UEs, and non-transitory computer-readable medium described herein, a baseband of the UE may be in a first baseband state associated with a first level of power consumption during the first time period, and whether the UE may be restricted to the first scheduling configuration during the second time period may be in accordance with whether the UE maintains the baseband of the UE in the first baseband state or switches the baseband of the UE to a second baseband state associated with a second level of power consumption that may be higher than the first level of power consumption.

In some examples of the method, UEs, and non-transitory computer-readable medium described herein, the second baseband state supports communications by the UE in accordance with a throughput that may be higher than the first maximum throughput, a processing timeline that may be shorter than the first minimum processing timeline, an absence of scheduling gaps between consecutive shared channel messages, or any combination thereof.

Some examples of the method, UEs, and non-transitory computer-readable medium described herein may further include operations, features, means, or instructions for switching the baseband of the UE to the second baseband state in response to receipt of the second control information associated with the multicast scheduling, where the UE not being restricted to the first scheduling configuration during the second time period in accordance with the second control information includes the baseband of the UE being in the second baseband state during the second time period in response to receipt of the second control information.

In some examples of the method, UEs, and non-transitory computer-readable medium described herein, the second control information associated with the multicast scheduling of the UE includes a common frequency resource (CFR) configuration associated with the multicast scheduling of the UE.

In some examples of the method, UEs, and non-transitory computer-readable medium described herein, the second control information associated with the multicast scheduling of the UE includes a multicast broadcast service (MBS) search space set (SSS) associated with group-common downlink control information (DCI).

In some examples of the method, UEs, and non-transitory computer-readable medium described herein, the second control information associated with the multicast scheduling of the UE includes a GC-DCI message that may be decodable by the UE.

In some examples of the method, UEs, and non-transitory computer-readable medium described herein, the UE may be restricted to the first scheduling configuration during the second time period in accordance with the second set of time and frequency resources spanning less than a threshold bandwidth and the second control information associated with the multicast scheduling indicating a processing timeline that may be longer than or equal to the first minimum processing timeline.

In some examples of the method, UEs, and non-transitory computer-readable medium described herein, the UE may be restricted to the first scheduling configuration during the second time period in accordance with the second control information associated with the second set of time and frequency resources spanning greater than a threshold bandwidth and the multicast scheduling indicating a processing timeline that may be longer than or equal to the first minimum processing timeline and further indicating a presence of scheduling gaps between consecutive multicast shared channel messages for the UE.

In some examples of the method, UEs, and non-transitory computer-readable medium described herein, the first set of time and frequency resources includes a first bandwidth part (BWP), the second set of time and frequency resources includes a CFR that at least partially overlaps the first BWP and a second BWP, and in accordance with the first set of time and frequency resources being associated with the first scheduling configuration, the second control information associated with the multicast scheduling may be also associated with the first scheduling configuration.

In some examples of the method, UEs, and non-transitory computer-readable medium described herein, the first set of time and frequency resources includes a first BWP, the second set of time and frequency resources includes a CFR that at least partially overlaps the first BWP and a second BWP, and in accordance with the CFR being associated with the first scheduling configuration, the first set of time and frequency resources remains associated with the first scheduling configuration.

In some examples of the method, UEs, and non-transitory computer-readable medium described herein, the first set of time and frequency resources includes a first BWP, the second set of time and frequency resources includes a CFR that at least partially overlaps the first BWP and a second BWP, and the second control information indicates a peak throughput for the multicast scheduling that may be less than or equal to the first maximum throughput, a processing timeline for the multicast scheduling that may be longer than or equal to the first minimum processing timeline, a duration of a scheduling gap between consecutive multicast shared channel messages for the UE, or any combination thereof.

In some examples of the method, UEs, and non-transitory computer-readable medium described herein, in accordance with the UE being restricted to the first scheduling configuration during the second time period, the second control information includes a GC-DCI message that indicates a processing timeline for a multicast data message that may be longer than or equal to the first minimum processing timeline.

In some examples of the method, UEs, and non-transitory computer-readable medium described herein, the processing timeline for the multicast data message may be from among a first set of processing timelines that may be each longer than or equal to the first minimum processing timeline and a second set of processing timelines associated with a second scheduling configuration includes at least one processing timeline that may be shorter than the first minimum processing timeline.

In some examples of the method, UEs, and non-transitory computer-readable medium described herein, the processing timeline for the multicast data message may be from among a first set of processing timelines that may be each longer than or equal to the first minimum processing timeline and the unicast scheduling may be associated a second set of processing timelines that may be each longer than or equal to the first minimum processing timeline, the second set of processing timelines being different from the first set of processing timelines.

In some examples of the method, UEs, and non-transitory computer-readable medium described herein, to indicate the processing timeline for the multicast data message, the GC-DCI message indicates an offset relative to a base processing timeline that may be shorter than the first minimum processing timeline.

In some examples of the method, UEs, and non-transitory computer-readable medium described herein, the second control information indicates a second duration of scheduling gaps between consecutive multicast shared channel messages for the UE that may be different than a first duration of the scheduling gaps between the consecutive unicast shared channel messages for the UE.

A method for wireless communications by a network entity is described. The method may include outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, outputting, to the UE during a first time period, one or more first unicast shared channel messages via the first set of time and frequency resources and in accordance with the first scheduling configuration, outputting second control information associated with multicast scheduling of the UE via a second set of time and frequency resources, and outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

A network entity for wireless communications is described. The network entity may include one or more memories storing processor executable code, and one or more processors coupled with the one or more memories. The one or more processors may individually or collectively be operable to execute the code to cause the network entity to output first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, output, to the UE during a first time period, one or more first unicast shared channel messages via the first set of time and frequency resources and in accordance with the first scheduling configuration, output second control information associated with multicast scheduling of the UE via a second set of time and frequency resources, and output, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

Another network entity for wireless communications is described. The network entity may include means for outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, means for outputting, to the UE during a first time period, one or more first unicast shared channel messages via the first set of time and frequency resources and in accordance with the first scheduling configuration, means for outputting second control information associated with multicast scheduling of the UE via a second set of time and frequency resources, and means for outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

A non-transitory computer-readable medium storing code for wireless communications is described. The code may include instructions executable by one or more processors to output first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE, output, to the UE during a first time period, one or more first unicast shared channel messages via the first set of time and frequency resources and in accordance with the first scheduling configuration, output second control information associated with multicast scheduling of the UE via a second set of time and frequency resources, and output, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

In some examples of the method, network entities, and non-transitory computer-readable medium described herein, a second scheduling configuration supports communications in accordance with a throughput that may be higher than the first maximum throughput, a processing timeline that may be shorter than the first minimum processing timeline, an absence of scheduling gaps between consecutive shared channel messages, or any combination thereof.

In some examples of the method, network entities, and non-transitory computer-readable medium described herein, the UE may be not restricted to the first scheduling configuration during the second time period in accordance with the second control information associated with multicast scheduling of the UE being output.

In some examples of the method, network entities, and non-transitory computer-readable medium described herein, the second control information associated with the multicast scheduling of the UE includes a CFR configuration associated with the multicast scheduling of the UE, a MBS-SSS associated with GC-DCI, or a GC-DCI message that may be decodable by the UE.

In some examples of the method, network entities, and non-transitory computer-readable medium described herein, the UE may be restricted to the first scheduling configuration during the second time period in accordance with the second set of time and frequency resources spanning less than a threshold bandwidth and the second control information associated with the multicast scheduling indicating a processing timeline that may be longer than or equal to the first minimum processing timeline.

In some examples of the method, network entities, and non-transitory computer-readable medium described herein, the UE may be restricted to the first scheduling configuration during the second time period in accordance with the second control information associated with the second set of time and frequency resources spanning greater than a threshold bandwidth and the multicast scheduling indicating a processing timeline that may be longer than or equal to the first minimum processing timeline and further indicating a presence of scheduling gaps between consecutive multicast shared channel messages for the UE.

In some examples of the method, network entities, and non-transitory computer-readable medium described herein, the first set of time and frequency resources includes a first BWP, the second set of time and frequency resources includes a CFR that at least partially overlaps the first BWP and a second BWP, and in accordance with the first set of time and frequency resources being associated with the first scheduling configuration, the second control information associated with the multicast scheduling may be also associated with the first scheduling configuration.

In some examples of the method, network entities, and non-transitory computer-readable medium described herein, the first set of time and frequency resources includes a first BWP, the second set of time and frequency resources includes a CFR that at least partially overlaps the first BWP and a second BWP, and in accordance with the CFR being associated with the first scheduling configuration, the first set of time and frequency resources remains associated with the first scheduling configuration.

In some examples of the method, network entities, and non-transitory computer-readable medium described herein, the first set of time and frequency resources includes a first BWP, the second set of time and frequency resources includes a CFR that at least partially overlaps the first BWP and a second BWP, and the second control information indicates a peak throughput for the multicast scheduling that may be less than or equal to the first maximum throughput, a processing timeline for the multicast scheduling that may be longer than or equal to the first minimum processing timeline, a duration of a scheduling gap between consecutive multicast shared channel messages for the UE, or any combination thereof.

In some examples of the method, network entities, and non-transitory computer-readable medium described herein, in accordance with the UE being restricted to the first scheduling configuration during the second time period, the second control information includes a GC-DCI message that indicates a processing timeline for a multicast data message that may be longer than or equal to the first minimum processing timeline.

In some examples of the method, network entities, and non-transitory computer-readable medium described herein, to indicate the processing timeline for the multicast data message, the group-common DCI message indicates an offset relative to a base processing timeline that may be shorter than the first minimum processing timeline.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support power efficient scheduling for multicast and unicast communications in accordance with one or more aspects of the present disclosure.

FIG. 3 shows examples of power state configurations that support power efficient scheduling for multicast and unicast communications in accordance with one or more aspects of the present disclosure.

FIG. 4 shows examples of power efficient scheduling configurations that support power efficient scheduling for multicast and unicast communications in accordance with one or more aspects of the present disclosure.

FIG. 5 shows an example of a process flow that supports power efficient scheduling for multicast and unicast communications in accordance with one or more aspects of the present disclosure.

FIGS. 6 and 7 show block diagrams of devices that support power efficient scheduling for multicast and unicast communications in accordance with one or more aspects of the present disclosure.

FIG. 8 shows a block diagram of a communications manager that supports power efficient scheduling for multicast and unicast communications in accordance with one or more aspects of the present disclosure.

FIG. 9 shows a diagram of a system including a device that supports power efficient scheduling for multicast and unicast communications in accordance with one or more aspects of the present disclosure.

FIGS. 10 and 11 show block diagrams of devices that support power efficient scheduling for multicast and unicast communications in accordance with one or more aspects of the present disclosure.

FIG. 12 shows a block diagram of a communications manager that supports power efficient scheduling for multicast and unicast communications in accordance with one or more aspects of the present disclosure.

FIG. 13 shows a diagram of a system including a device that supports power efficient scheduling for multicast and unicast communications in accordance with one or more aspects of the present disclosure.

FIGS. 14 and 15 show flowcharts illustrating methods that support power efficient scheduling for multicast and unicast communications in accordance with one or more aspects of the present disclosure.

### DETAILED DESCRIPTION

A user equipment (UE) may have different capabilities to operate in both high-power states and low-power (e.g., power efficient) states based on different network scheduling types, latency requirements, and peak throughput. For example, to accommodate high throughput traffic and wideband scheduling, a UE may enter a high power state in order to shift the baseband of the UE to a higher clock frequency and higher voltage supplies. Conversely, for lower throughput traffic and narrowband scheduling, the UE may support a low baseband state or a low power state to improve power savings for the UE.

In some aspects, a UE may support both unicast and multicast scheduling as part of a bandwidth part (BWP) configuration. For example, a UE may be configured with a BWP that at least partially overlaps with a BWP of another UE, with the overlapping region of the two BWPs being a common frequency resource (CFR) used for wideband multicast scheduling. In some cases, however, if the UE is operating in a power efficient BWP (e.g., a BWP with limited throughput power efficient scheduling) and is scheduled for multicast, the multicast scheduling may force the UE to transition a high power state to accommodate shorter feedback timelines and increased throughput associated with some multicast communications. The automatic transition to a high power state may increase power costs for the UE and, in at least some cases, may effectively override power saving benefits from the power efficient BWP scheduling.

In order to enable power efficient scheduling for a UE configured with both unicast and multicast communications, the UE may implement various techniques to support multicast scheduling for both high power and power efficient scheduling types. In some examples, the UE may remain in a power efficient (e.g., low power) mode if the network indicates a relaxed feedback processing timeline and reduced throughput are configured for a multicast scheduling (or for both multicast and unicast scheduling). In such cases, the UE may remain in a low baseband state since the network indicates power efficient scheduling for the multicast communications. Additionally, or alternatively, if the network indicates power efficient scheduling for a BWP, the UE may not expect to process a physical downlink shared channel (PDSCH) with a reduced processing timeline or high throughput within the power efficient BWP (or within the CFR). In some other examples, the network may indicate different relaxed feedback processing time values that the UE may support for multicast scheduling. In some other examples, if the UE is configured to receive both multicast and unicast communications, the UE may transition to a high power state upon receiving a CFR configuration, upon configuration of a search space set for receiving group common downlink control information (DCI) for multicast, or upon receiving and successful decoding of the group common DCI.

Aspects of the disclosure may be implemented to realize one or more potential advantages. For example, the techniques described herein may allow for power efficient scheduling for a UE configured to support both unicast and multicast communications, such that the UE may remain in a power efficient communication mode while performing multicast communications (rather than automatically switching from a lower power state to a higher power state upon being configured with multicast scheduling). In such examples, the UE may maintain its baseband state in a first (e.g., low power) baseband state while supporting multicast communications rather than automatically switching to a second (e.g., higher power) baseband state. Additionally, or alternatively, the techniques described herein may allow for increased device coordination and more flexible multicast scheduling, including increased feedback and processing timelines for multicast, flexible scheduling with time domain gaps between multicast communications, and support for both increased and reduced throughput for multicast scheduling. Additionally, or alternatively, the techniques described herein may allow for flexible configuration of power efficient scheduling for multicast built into the BWP configuration framework. For example, as part of a CFR configuration within a BWP configuration, the UE may be configured to process the multicast communications using reduced peak throughput, and with relaxed feedback processing timelines.

Aspects of the disclosure are initially described in the context of wireless communications systems. Aspects of the disclosure are further illustrated by and described with reference to power state configurations, power efficient scheduling configurations, a process flow, apparatus diagrams, system diagrams, and flowcharts that relate to power efficient scheduling for multicast and unicast communications.

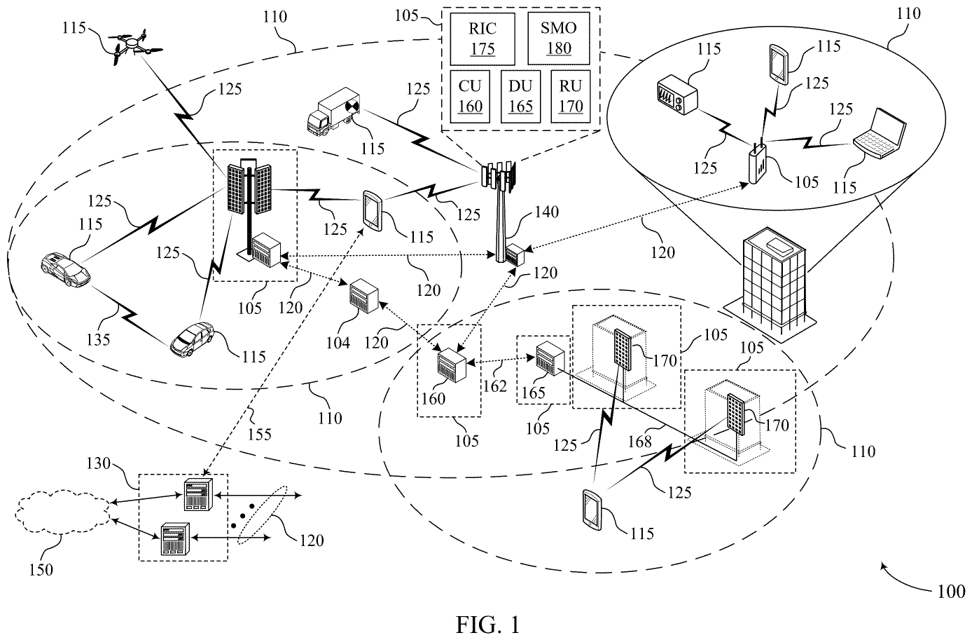

FIG. 1 shows an example of a wireless communications system 100 that supports power efficient scheduling for multicast and unicast communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support power efficient scheduling for multicast and unicast communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support power efficient scheduling based on peak rate reduction. For example, a UE 115 may support an initial or baseline peak rate:

$$data rate ( in Mbps ) = {10}^{- 6} \cdot {\sum }_{j = 1}^{J} ( {v}_{L a y e r s}^{( j )} \cdot {Q}_{m}^{( j )} \cdot {z}^{( j )} \cdot {f}^{( j )} \cdot R \frac{{N}_{P R B}^{BW ( j ) , μ} \cdot 12}{{T}_{s}^{μ}} {( 1 - {OH}^{( j )} )}_{max} ) .$$

A network entity 105 may then indicate a reduced peak rate by indicating or signaling a scaling factor z^{(j)} that the UE 115 may use to scale the peak rate. The network entity 105 may also indicate a processing timeline relaxation of N1+X ms (and a corresponding feedback timeline relaxation), and a set of DRX slots between scheduled PDSCHs which may allow for reduced peak rate for the UE 115. The UE 115 may support the reduced peak rate as:

$$data rate ( in Mbps ) = {10}^{- 6} \cdot {\sum }_{j = 1}^{J} ( {v}_{L a y e r s}^{( j )} \cdot {Q}_{m}^{( j )} \cdot {f}^{( j )} \cdot R \frac{{N}_{P R B}^{BW ( j ) , μ} \cdot 12}{{z}^{( j )} {T}_{s}^{μ}} {( 1 - {OH}^{( j )} )}_{max} ) .$$

A UE 115 may include a baseband (e.g., a baseband processor, a baseband radio processor) included in a chip or part of a chip in a network interface controller that manages different radio functions of the UE 115. In some implementations, the UE 115 may utilize different operational states, including different power and baseband processing states. For example, the UE 115 may support a first power state (e.g., a high radio frequency, low baseband power state), where the UE 115 may support a maximum or threshold radio frequency bandwidth with reduced throughput, one or more activated component carriers (e.g., a fraction of the total configured component carriers may be activated), an extended or relaxed feedback processing timeline, or any combination thereof. When operating in the first power state, the UE 115 may remain in a lower power expenditure state, such that the UE 115 refrains from ramping up its internal clock rate and refrains from powering up the internal clock to a high voltage. Instead, the UE 115 operating in the first power state may gradually increase the internal clock and gradually increase voltage in order to conserve energy.

Additionally, or alternatively, the UE 115 may support a second power state (e.g., a high radio frequency, high baseband power state), where the UE 115 may support a maximum radio frequency bandwidth, with one or more activated component carriers, a reduced or tight feedback processing timeline, or any combination thereof. When operating in the second power state, the UE 115 may operate in a higher power expenditure state, and may increase its internal clock frequency and voltage in order to support ongoing communications. In some aspects, the UE 115 may operate in accordance with the first power state when accommodating one shot wideband scheduling of a downlink burst, or when scheduled communications are delay tolerant (or latency tolerant), among other relatively lower priority communications. Alternatively, the UE 115 may operate in accordance with the second power state when accommodating full buffer traffic, long bursts of traffic at or near peak throughput, high priority traffic, low latency traffic, among other conditions.

In some aspects, a UE 115 may support both unicast and multicast scheduling as part of a BWP configuration. For example, a UE 115 may be configured with a BWP that at least partially overlaps with a BWP of another UE 115, with the overlapping region of the two BWPs being a CFR used for wideband multicast scheduling. In some cases, however, if the UE 115 is operating in a power efficient BWP (e.g., a BWP with limited throughput power efficient scheduling) and is scheduled for multicast, the multicast scheduling may force the UE 115 to transition a high power state to accommodate shorter feedback timelines and increased throughput associated with some multicast communications. The automatic transition to a high power state may increase power costs for the UE 115 and, in at least some cases, may effectively override power saving benefits from the power efficient BWP scheduling.

In order to enable power efficient scheduling for a UE 115 configured with both unicast and multicast communications, the UE 115 may implement various techniques to support multicast scheduling for both high power and power efficient scheduling types. In some examples, the UE 115 may remain in a power efficient (e.g., low power) mode if a network entity 105 indicates a relaxed feedback processing timeline and reduced throughput are configured for a multicast scheduling (or for both multicast and unicast scheduling). Additionally, or alternatively, if the network entity 105 indicates power efficient scheduling for a BWP, the UE 115 may not expect to process a PDCSH with a reduced processing timeline or high throughput within the power efficient BWP (or within the CFR). In some other examples, the network entity 105 may indicate different relaxed feedback processing time values that the UE 115 may support for multicast scheduling. In some other examples, if the UE 115 is configured to receive both multicast and unicast communications, the UE may transition to a high power state after receiving a CFR configuration, after configuration of a search space set for receiving group common DCI for multicast, or after receiving and successful decoding of the group common DCI.

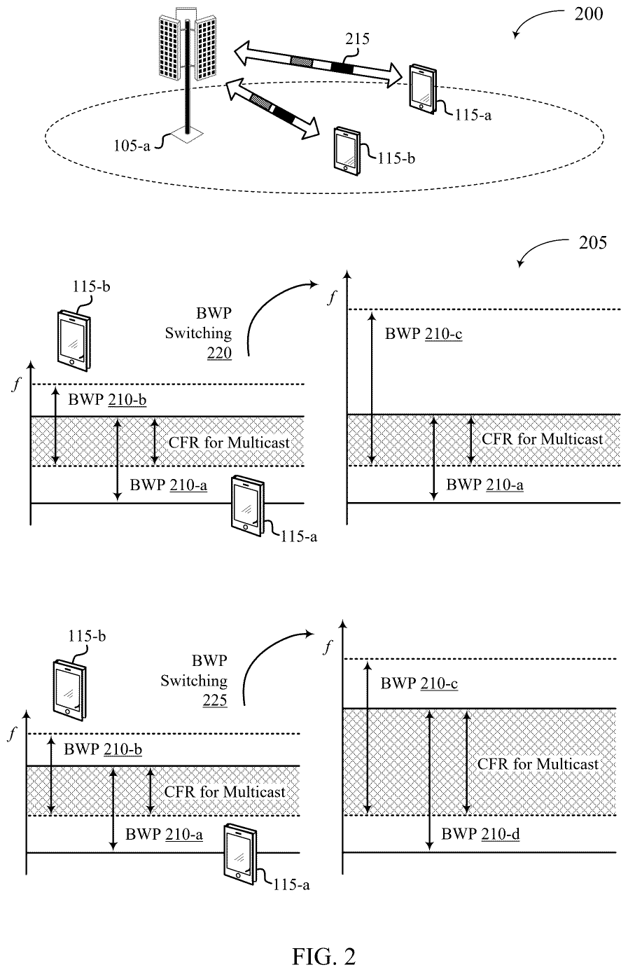

FIG. 2 shows an example of a wireless communications system 200 that supports power efficient scheduling for multicast and unicast communications in accordance with one or more aspects of the present disclosure. For example, the wireless communications system 200 illustrates communications between a network entity 105-a (which may be an example of a network entity 105 described with reference to FIG. 1), a UE 115-a, and a UE 115-b (each of which may be examples of UEs 115 described with reference to FIG. 1. The network entity 105-a, the UE 115-a, and the UE 115-b may be configured to support both unicast and multicast communications.

The UE 115-a and the UE 115-b may support different capabilities for operation in both high power states and low-power (e.g., power efficient) states based on different scheduling, latency requirements, and traffic types. For example, for high throughput traffic and wideband scheduling, the UE 115-a, the UE 115-b, or both, may enter a high power state in order to shift to a higher baseband state, including a higher clock frequency and higher voltage supplies to accommodate high traffic rates associated with the wideband scheduling. Such high power modes may provide high performance due to higher clock frequency and higher supply voltage, but may reduce power efficiency and leakage.

The UE 115-a and the UE 115-b may also support power efficient operational modes for reduced power consumption. For example, the network entity 105-a may transmit signaling that indicates a timeline of how long the UE 115-a or the UE 115-b may be scheduled for wideband communications so that the UE 115-a or the UE 115-b may set respective clock frequencies and voltage for when wideband scheduling is applicable, and not for other times (such as times where the UE 115-a or the UE 115-b are scheduled for narrowband).

Additionally, or alternatively, the UE 115-a and the UE 115-b may support power efficient scheduling for lower throughput traffic and narrowband scheduling, such that the UE 115-a and the UE 115-b may enter a low power state or an “power efficient” state to save power. In such power efficient states, the network entity 105-a may transmit an indication that the UE 115-a and the UE 115-b will not be scheduled with sustained peak throughput, so that the UE 115-a and the UE 115-b may refrain from ramping up to a highest power state. In some aspects, the indication that the network entity 105-a transmits may include a throughput indication, for example, indicating that the maximum scheduled throughput will be less than or equal to a threshold throughput. The indication may also include a feedback timeline or a processing timeline that is less than or equal to a threshold timeline. The indication may also indicate scheduled gaps between PDSCHs transmitted to the UE 115-a and the UE 115-b (which may be indicative of the reduced throughput or power efficient scheduling when downlink data is less than a peak throughput and feedback timing is reduced). In some aspects, the power efficient scheduling may allow for decoupling of radio frequency power and the baseband power (e.g., a UE may move radio frequency power to a high power state while keeping the baseband power in a low power state), which may reduce overall device power expenditure.

In some aspects, a UE may support both unicast and multicast scheduling as part of a BWP configuration 205. For example, the UE 115-a may be configured with a BWP 210-a that at least partially overlaps with a BWP 210-b of the UE 115-b, with the overlapping region of the two BWPs being a CFR used for wideband multicast scheduling. In some aspects, the network entity 105-a may configure one CFR for multicast via control signaling 215 (e.g., RRC signaling). For example, the control signaling 215 may include one or more fields that configures the multicast signaling, including a PDCCH multicast configuration field (e.g., PDCCH-config-Multicast) that is configured separately from the PDCCH unicast configuration field. The PDCCH multicast configuration field may configure a control resource set (CORESET) within the CFR, a common search space (CSS) (e.g., a type 3 CSS), or both, which may be configured to schedule a group-common (GC) PDCCH. The PDCCH multicast may also indicate scheduling for the GC-PDSCH in the CFR using a same GC radio network temporary identifier (RNTI) as for a GC-PDCCH. The control signaling 215 may also include a semi-persistent scheduling (SPS) configuration field (e.g., SPS-config-Multicast) separate from SPS configuration for unicast. In such SPS scheduling, one or multiple SPS configurations may be associated with one or more group configured scheduling (G-CS) RNTIs. In addition, the control signaling 215 may indicate a starting physical resource block (PRB) and a quantity of PRBs configured for the CFR, a subcarrier spacing of the CFR, a cyclic prefix of the CFR based on the BWP configuration, or both, which may enable dynamic switching between unicast and multicast communications.

In some cases, the UE 115-b may undergo BWP switching 220 (e.g., the UE 115-b may perform BWP switching or may receive a BWP switching trigger) from the BWP 210-b to a BWP 210-c (a wider BWP), which may support power efficient scheduling. For example, the BWP 210-c may support wider bandwidth range, wideband scheduling, reduced peak throughput with discontinuous scheduling and relaxed feedback timelines, or any combination thereof. The BWP switching 220 to the BWP 210-b may support power efficient operations for the UE 115-b. In some cases, however, if the UE 115-b receives a multicast scheduling, the multicast scheduling may force the baseband clock of the UE 115-b to a higher power state, which may reduce potential energy saving benefits from the power efficient BWP switch. For example, if the UE 115-b detects a GC-PDSCH (even a narrowband GC-PDSCH) the UE 115-b may switch the baseband state of the UE 115-b to a higher power state to support the multicast scheduling. In such cases, the multicast scheduling may force the UE 115-b to (sometimes unnecessarily) go into a high power state (since multicast may not guarantee relaxed feedback or reduced throughput). Such increases in power state may increase the power costs for the UE 115-b and effectively overrides any benefit from the power efficient BWP scheduling.

Additionally, or alternatively, both the UE 115-a and the UE 115-b may perform BWP switching (e.g., BWP switching 225) which may result in a wider CFR for multicast scheduling. For example, the UE 115-a may perform BWP switching 225 to a BWP 210-d (which may be a power efficient BWP) and the UE 115-b may perform BWP switching 225 to the BWP 210-c (which may be a power efficient BWP). Similar to BWP switching for a single UE, however, a multicast scheduling for one or both UEs may drive the baseband state for the UE into a higher power state, which may reduce the potential power saving gains from the power efficient scheduling.

In order to increase power savings from power efficient scheduling, the UE 115-a and the UE 115-b may support various different techniques to enable power efficient scheduling for both multicast and unicast communications. In some examples, the UE 115-a and the UE 115-b may remain in a power efficient low power mode if the network entity 105-a indicates that feedback processing timelines and reduced throughput are supported for a multicast scheduling (or for both multicast and unicast). In some examples, the UE 115-a and the UE 115-b may not expect to process a unicast PDSCH with a reduced processing timeline or high throughput if the network entity 105-a indicates that power efficient scheduling for a currently configured BWP. In some other examples, the network entity 105-a may indicate different relaxed feedback processing time values that the UE 115-a and the UE 115-b may support for multicast scheduling. Additionally, or alternatively, if the UE 115-a or the UE 115-b are configured to receive both multicast and unicast communications, the UE 115-a or the UE 115-b, or both, may transition to a high power state after receiving a CFR configuration, after configuration of a search space set for receiving group common DCI, or after receiving and decoding of the group common DCI.

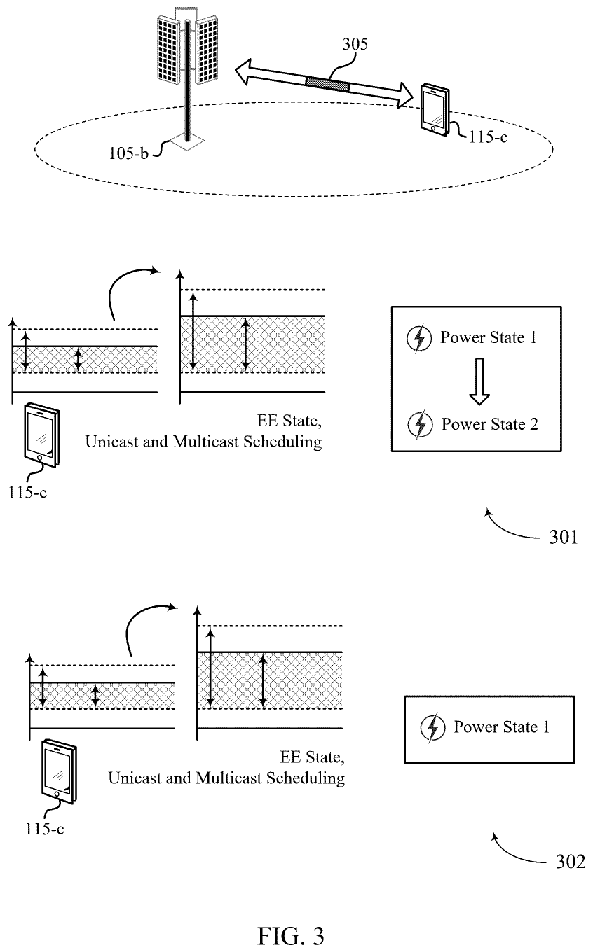

FIG. 3 shows an examples of power state configurations 301 and 302 that support power efficient scheduling for multicast and unicast communications in accordance with one or more aspects of the present disclosure. For example, the power state configurations 301 and 302 illustrate communications between a network entity 105-b (which may be an example of a network entity 105 described with reference to FIGS. 1 and 2), and a UE 115-c (which may be an example of UEs 115 described with reference to FIGS. 1 and 2). The network entity 105-b and the UE 115-c may be configured to support both unicast and multicast communications.

In some aspects, the UE 115-c may support unicast communications (based on unicast scheduling via signaling 305), multicast communications (based on multicast scheduling via signaling 305), or both. In addition, the UE 115-c may support power efficient unicast and multicast scheduling, where the UE 115-c may receive an indication of reduced peak throughput, processing or feedback timeline relaxations, timing gaps between scheduled PDSCH transmissions, or any combination thereof. The UE 115-c may support various different techniques to support power efficient multicast and unicast scheduling, including transitioning between higher power states and lower power states, maintaining a lower power state, or both.

In power state configuration 301, the UE 115-c may be configured to receive both multicast and unicast communications. Based on the configuration of both unicast and multicast, the UE 115-c may transition from the first power state (e.g., power state 1, a low power baseband state) to the second power state (e.g., power state 2, a higher power baseband state). In some aspects, the second power state may support non-reduced peak throughput mode (e.g., a high throughput mode), with reduced processing or feedback timing relaxations, without timing gaps between PDSCHs. In some implementations, the UE 115-c may perform the transition from the first power state to the second power state after receiving a CFR configuration from the network entity 105-b, which configures the CFR for the multicast scheduling. In some implementations, the UE 115-c may perform the transition from the first power state to the second power state after the network entity 105-b configures a multicast broadcast service (MBS) search space set (SSS) that the UE 115-b may use for monitoring for GC-DCI associated with the multicast scheduling. In some implementations, the UE 115-c may perform the transition from the first power state to the second power state after the UE 115-c receives a valid GC-DCI that passes a cyclic redundancy check (CRC).

In power state configuration 302, the UE 115-c may be configured to receive both multicast and unicast communications, and may be operating in the first power state (e.g., power state 1, a power efficient energy state that supports reduced peak throughput, a relaxed feedback and processing timeline, time domain gaps between scheduled PDSCHs, or any combination thereof). In some examples, the UE 115-c may remain in the first power state (e.g., the power efficient state) for both unicast and multicast communications if the network entity 105-b indicates that the feedback timeline or processing timeline is relaxed for narrowband low latency multicast scheduling. For example, the network entity 105-a may indicate that the feedback timeline or processing timeline is greater than or equal to a threshold timeline for multicast, and the UE 115-c may remain in the first power state. Additionally, or alternatively, the UE 115-c may remain in the first power state if the network entity 105-b indicates that the feedback timeline or processing timeline is relaxed for wideband multicast, and that there are time domain gaps between scheduled PDSCHs for the wideband multicast scheduling. For example, if the network entity 105-c indicates that the feedback or processing timeline is greater than or equal to a threshold timeline, and that there are a greater than or equal to a threshold quantity of gaps between scheduled PDSCHs, the UE 115-c may remain in the first power state. Additionally, or alternatively, the network entity 105-b may indicate, to the UE 115-c, that the multicast scheduling may not cause restrictions on unicast scheduling, or that the UE 115-c may otherwise remain in a power efficient mode to support the multicast scheduling.

In some aspects, while operating in the first power state, the UE 115-c may be configured with power efficient unicast scheduling and may support multicast scheduling and multicast communications without transitioning into the second power state. In some implementations, the UE 115-c may perform BWP switching to a power efficient wider BWP, and as part of BWP switching, the UE 115-c may be scheduled with a wideband scheduling of unicast PDSCHs (where the wideband unicast PDSCH scheduling is associated with reduced peak throughput, time domain gaps between unicast PDSCHs, and relaxed processing or feedback timelines). In such cases, after performing the BWP switching to the power efficient BWP, the UE 115-c may not (e.g., may not expect) to process a multicast PDSCH within a CFR of another configured BWP that has a shorter processing timeline, a higher peak throughput (e.g., without time domain gaps between GC-PDSCHs), or both.

For example, if the UE 115-c is configured with multiple BWPs, including at least one active power efficient BWP for multicast, the UE 115-c may not expect to receive communications in another configured BWP that would force the UE 115-c into the second power state. In some such examples, the UE 115-c may remain in the first power state (e.g., the power efficient state) for both unicast and multicast communications if the network entity 105-b indicates that the feedback timeline or processing timeline is relaxed for narrowband low latency multicast scheduling. Additionally, or alternatively, the UE 115-c may remain in the first power state if the network entity 105-b indicates that the feedback timeline or processing timeline is relaxed for wideband multicast, and that there are time domain gaps between scheduled PDSCHs for the wideband multicast scheduling (e.g., reduced peak throughput). Additionally, or alternatively, the network entity 105-b may indicate, to the UE 115-c, that the multicast scheduling may not cause restrictions on unicast scheduling, or that the UE 115-c may otherwise remain in a power efficient mode to support the multicast scheduling.

In some aspects, as part of a BWP switching procedure, the UE 115-c may not expect to process unicast PDSCH within the BWP with a reduced processing timeline, high throughput, reduced time domain gaps between PDSCHs, or any combination thereof. For example, if the UE 115-c performs BWP switching from a narrow BWP to a power efficient wider BWP (with a power efficient wider CFR that supports reduced peak throughput, duty cycle scheduling with gaps between GC-PDSCHs, reduced processing or feedback timelines, or any combination thereof), the UE 115-c may not expect to receive a PDSCH within the power efficient BWP that has a reduced processing timeline, high throughput, reduced time domain gaps between PDSCHs, or any combination thereof.

In some aspects, the network entity 105-b may transmit a CFR configuration to the UE 115-c (e.g., within a BWP configuration, and separate from unicast signaling) which indicates that the UE 115-c may support one or more power efficient techniques for processing GC-PDSCHs for multicast while operating in the first power state. For example, the CFT configuration may indicate UE-specific peak throughput scaling (e.g., a time dilation indication associated with reduced throughput for the UE 115-c), a quantity of guaranteed or configured time domain gaps between scheduled GC-PDSCHs, or both, which may allow the UE 115-c to support the first power state. Additionally, or alternatively, the CFR configuration may indicate UE-specific relaxation in feedback or processing timelines for GC-PDSCHs, which may allow the UE 115-c to remain in the first power state.

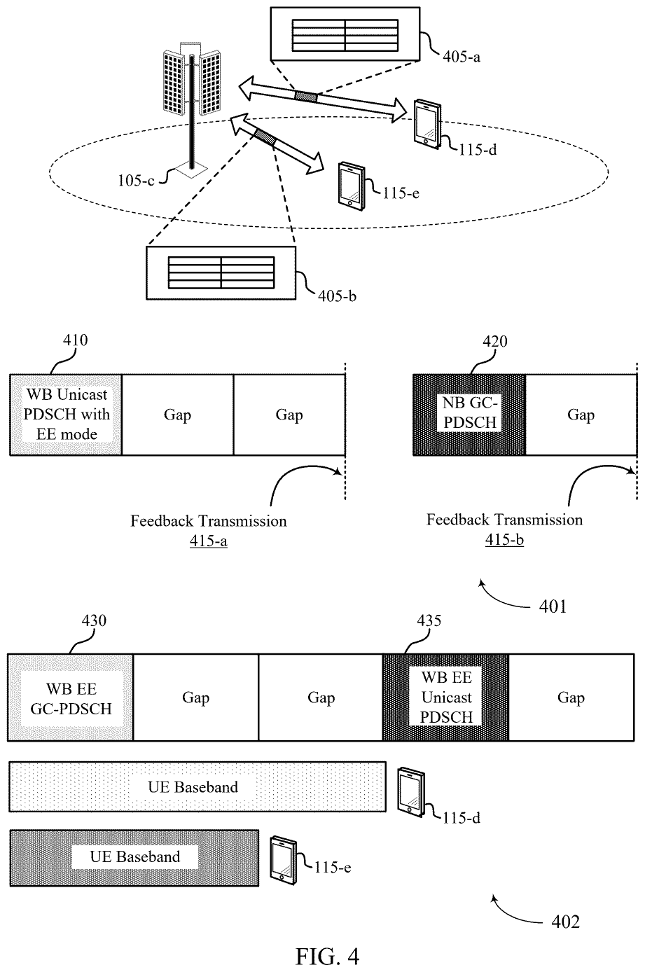

FIG. 4 shows an example of power efficient scheduling configurations 401 and 402 that support power efficient scheduling for multicast and unicast communications in accordance with one or more aspects of the present disclosure. For example, the power efficient scheduling configurations 401 and 402 may illustrate communications between a network entity 105-c (which may be an example of a network entity 105 described with reference to FIGS. 1-3), a UE 115-d, and a UE 115-c (each of which may be examples of UEs 115 described with reference to FIGS. 1-3). The network entity 105-c, the UE 115-d, and the UE 115-e may be configured to support both unicast and multicast communications.

The UE 115-d and the UE 115-e may support power efficient scheduling for multicast communications. For example, the UE 115-d may receive a GC-DCI 405-a and the UE 115-e may receive a GC-DCI 405-b, which may schedule multicast communications. In some examples, the GC-DCI 405-a and the GC-DCI 405-b may include feedback timing indicator fields (e.g., PDSCH-to-HARQ_feedback timing indicator fields) that may indicate a per-UE look up table or per-UE list of values that the UE 115-d and the UE 115-e may use for determining a feedback timeline for multicast communications. For example, the network entity 105-c may configure the UE 115-d and the UE 115-e with per-UE sets of feedback timing values (e.g., K1 values) associated with a normal mode of operation (e.g., a non-power efficient mode), and a modified list of feedback timing values (e.g., modified K1 values, extended K1 values) associated with a power efficient mode of operation for receiving, processing, and transmitting feedback for narrowband or wideband multicast PDSCHs.

For example, power efficient scheduling configuration 401 illustrates a first feedback processing timeline in which the UE 115-d receives a wideband unicast PDSCH 410 while operating in a power efficient mode. The UE 115-d may process the wideband unicast PDSCH 410 in accordance with a relaxed processing timeline (e.g., including gaps) and may transmit the feedback transmission 415-a after the relaxed processing timeline elapses. In addition, the UE 115-d may receive a narrowband GC-PDSCH 420, and based on the relaxed feedback timing values, the lower clock timing set by the wideband unicast PDSCH 410, or both, may transmit the feedback transmission 415-b according to a relaxed feedback timeline.

In some aspects, the GC-DCI 405-a and the GC-DCI 405-b may include an offset field which may indicate UE-specific offsets for relaxation of the feedback timing indicator (e.g., the PDSCH-to-HARQ_feedback timing indicator). For example, the offset field may indicate additional time added for the UE 115-d to process the GC-PDSCH. In some aspects, the timing relaxation for processing the GC-PDSCH may be the same or different from a timing for processing unicast PDSCH.

Additionally, or alternatively, the network entity 105-c may indicate a reduced peak throughput scaling (e.g., indicating a quantity of time domain gaps included after a scheduling) for multicast which may be the same as or different from peak throughput scaling for unicast. In some examples, the network entity 105-c may indicate, via RRC signaling, configured gaps between PDSCHs in the CFR. In some examples, the network entity 105-c may indicate, via one or more DCIs, time domain gaps between scheduled PDSCHs as part of a time domain resource allocation (TDRA) indication in the one or more DCIs.

In some aspects, different UEs may support different processing timelines based on different baseband power states or capabilities. For example, the power efficient scheduling configuration 402 illustrates the UE 115-d and the UE 115-e receiving a wideband GC-PDSCH 430 associated with power efficient scheduling (e.g., energy efficient “EE” GC-PDSCH). The UE 115-d may process the wideband GC-PDSCH 430 according to a baseband of the UE 115-d, and the UE 115-e may process the wideband GC-PDSCH 430 according to the baseband of UE 115-e (which may be different from the baseband of UE 115-d). For example, the baseband of the UE 115-e may support a higher power state and a faster processing timeline than the baseband of the UE 115-d. The UE 115-d and the UE 115-e may then receive a wideband unicast PDSCH 435 after processing the wideband GC-PDSCH 430 according to the different baseband states.

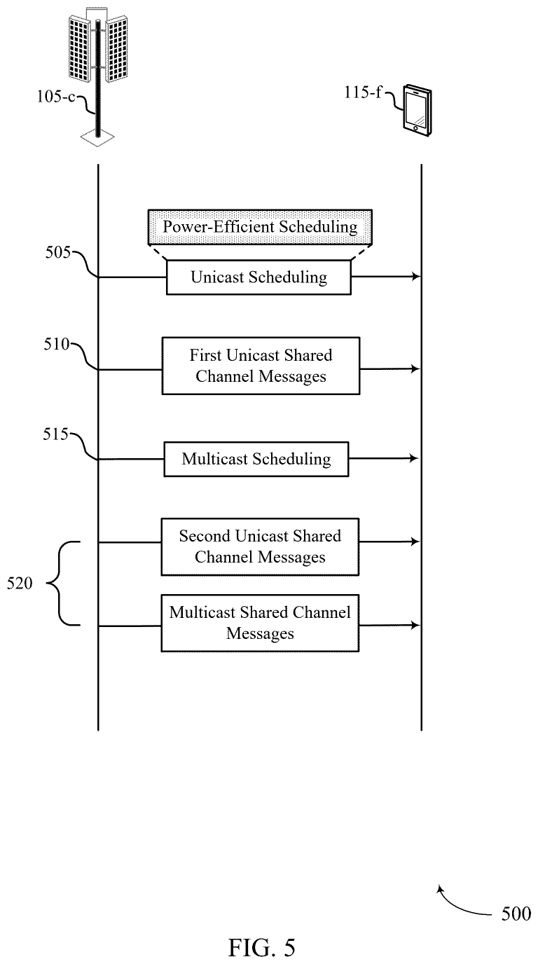

FIG. 5 shows an example of a process flow 500 that supports power efficient scheduling for multicast and unicast communications in accordance with one or more aspects of the present disclosure. In some examples, process flow 500 may implement aspects of, or be implemented by aspects of, the wireless communications system 100 or the wireless communications system 200. In some aspects, the process flow 500 may include a UE 115-f and a network entity 105-c which may be examples of corresponding devices described with reference to FIGS. 1-4.

In the following description of the process flow 500, the operations between the network entity 105-c and the UE 115-f may be performed in different orders or at different times than the example shown. Some operations may also be omitted from the process flow 500, and other operations may be added to the process flow 500. In this example, the network entity 105-c and the UE 115-f may support device coordination for multicast and unicast communications, including power efficient scheduling.

At 505, the UE 115-f may receive first control information associated with unicast scheduling of the UE 115-f via a first set of time and frequency resources in accordance with a first scheduling configuration. In some aspects, the first scheduling configuration is in accordance with a first maximum throughput, a first minimum processing timeline, and scheduling gaps between consecutive unicast shared channel messages for the UE 115-f.

At 510, the UE 115-f may receive, during a first time period, one or more first unicast shared channel messages via the first set of time and frequency resources and in accordance with the first scheduling configuration.

At 515, the UE 115-f may receive second control information associated with multicast scheduling of the UE via a second set of time and frequency resources.

At 520, the UE 115-f may receive, during a second time period, one or more second unicast shared channel messages via the first set of time and frequency resources and one or more multicast shared channel messages via the second set of time and frequency resources. In some aspects, whether the UE 115-f is restricted to the first scheduling configuration during the second time period is in accordance with the second control information associated with the multicast scheduling.

In some implementations, a baseband of the UE 115-f may be in a first baseband state associated with a first level of power consumption (e.g., a power efficient state) during the first time period, and whether the UE 115-f is restricted to the first scheduling configuration during the second time period is in accordance with whether the UE 115-f maintains the baseband in the first baseband state or switches the baseband to a second baseband state associated with a second level of power consumption that is higher than the first level of power consumption. In some cases, the second baseband state supports communications by the UE 115-f in accordance with a throughput that is higher than the first maximum throughput, a processing timeline that is shorter than the first minimum processing timeline, an absence of scheduling gaps between consecutive shared channel messages, or any combination thereof.

In some implementations, the UE 115-f may switch the baseband to the second baseband state in response to receipt of the second control information associated with the multicast scheduling. In some cases, the UE 115-f not being restricted to the first scheduling configuration during the second time period is in accordance with the second control information, and in accordance with the baseband of the UE being in the second baseband state during the second time period in response to receipt of the second control information. In some examples, the second control information associated with the multicast scheduling of the UE 115-f includes a CFR configuration associated with the multicast scheduling of the UE 115-f, a MBS-SSS associated with GC-DCI, or a GC-DCI that is decodable by the UE 115-f (e.g., a GC-DCI that passes a CRC check).

In some implementations, the UE 115-f may be restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline. In some implementations, the UE 115-f may be restricted to the first scheduling configuration during the second time period in accordance with the second control information associated with the second set of time and frequency resources spanning greater than a threshold bandwidth, and the multicast scheduling indicating a processing timeline that is longer than or equal to the first minimum processing timeline and further indicating a presence of scheduling gaps between consecutive multicast shared channel messages for the UE 115-f.

In some examples, the first set of time and frequency resources may include a first BWP, and the second set of time and frequency resources may include a CFR that at least partially overlaps the first BWP and a second BWP. In some such examples, the second control information associated with the multicast scheduling is also associated with the first scheduling configuration in accordance with the first set of time and frequency resources being associated with the first scheduling configuration.

In some examples, the first set of time and frequency resources may be a first BWP, and the second set of time and frequency resources may be a CFR that at least partially overlaps the first BWP and a second BWP. In some such examples, the first set of time and frequency resources remains associated with the first scheduling configuration in accordance with the CFR being associated with the first scheduling configuration.

In some examples, the first set of time and frequency resources may include a first BWP, and the second set of time and frequency resources includes a CFR that at least partially overlaps the first BWP and a second BWP. In some such examples, the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE 115-f, or any combination thereof.

In some examples, in accordance with the UE 115-f being restricted to the first scheduling configuration during the second time period, the second control information may include a GC-DCI message that indicates a processing timeline for a multicast data message that is longer than or equal to the first minimum processing timeline. In some such examples, the processing timeline for the multicast data message is from among a first set of processing timelines that are each longer than or equal to the first minimum processing timeline, and a second set of processing timelines associated with a second scheduling configuration includes at least one processing timeline that is shorter than the first minimum processing timeline. Additionally or alternatively, the processing timeline for the multicast data message is from among a first set of processing timelines that are each longer than or equal to the first minimum processing timeline and the unicast scheduling is associated a second set of processing timelines that are each longer than or equal to the first minimum processing timeline. In some aspects, the second set of processing timelines may be different from the first set of processing timelines. Additionally or alternatively, to indicate the processing timeline for the multicast data message, the GC-DCI message indicates an offset relative to a base processing timeline that is shorter than the first minimum processing timeline. In some examples, the second control information indicates a second duration of scheduling gaps between consecutive multicast shared channel messages for the UE 115-f that is different than a first duration of the scheduling gaps between the consecutive unicast shared channel messages for the UE 115-f.

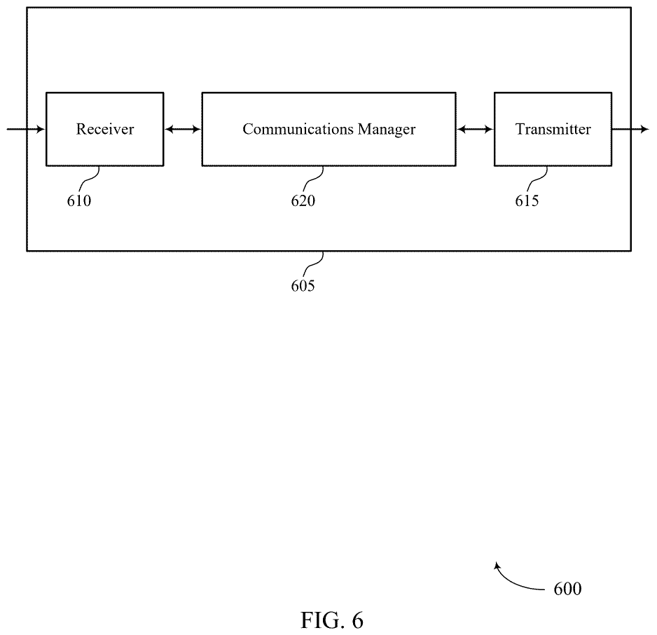

FIG. 6 shows a block diagram 600 of a device 605 that supports power efficient scheduling for multicast and unicast communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to power efficient scheduling for multicast and unicast communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power efficient scheduling for multicast and unicast communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of power efficient scheduling for multicast and unicast communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The communications manager 620 is capable of, configured to, or operable to support a means for receiving, during a first time period, one or more first unicast shared channel messages via the first set of time and frequency resources and in accordance with the first scheduling configuration. The communications manager 620 is capable of, configured to, or operable to support a means for receiving second control information associated with multicast scheduling of the UE via a second set of time and frequency resources. The communications manager 620 is capable of, configured to, or operable to support a means for receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources

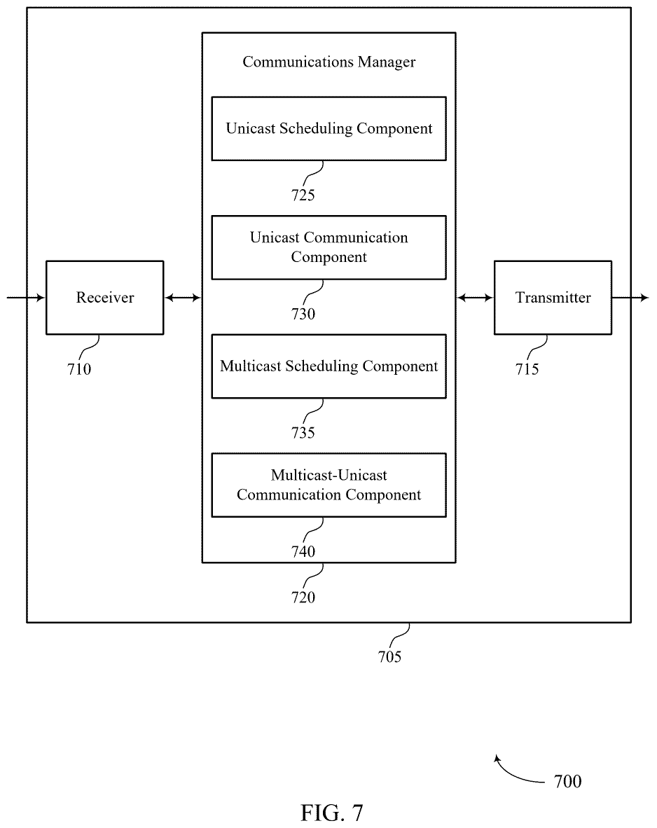

FIG. 7 shows a block diagram 700 of a device 705 that supports power efficient scheduling for multicast and unicast communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to power efficient scheduling for multicast and unicast communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to power efficient scheduling for multicast and unicast communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of power efficient scheduling for multicast and unicast communications as described herein. For example, the communications manager 720 may include a unicast scheduling component 725, a unicast communication component 730, a multicast scheduling component 735, a multicast-unicast communication component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The unicast scheduling component 725 is capable of, configured to, or operable to support a means for receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The unicast communication component 730 is capable of, configured to, or operable to support a means for receiving, during a first time period, one or more first unicast shared channel messages via the first set of time and frequency resources and in accordance with the first scheduling configuration. The multicast scheduling component 735 is capable of, configured to, or operable to support a means for receiving second control information associated with multicast scheduling of the UE via a second set of time and frequency resources. The multicast-unicast communication component 740 is capable of, configured to, or operable to support a means for receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

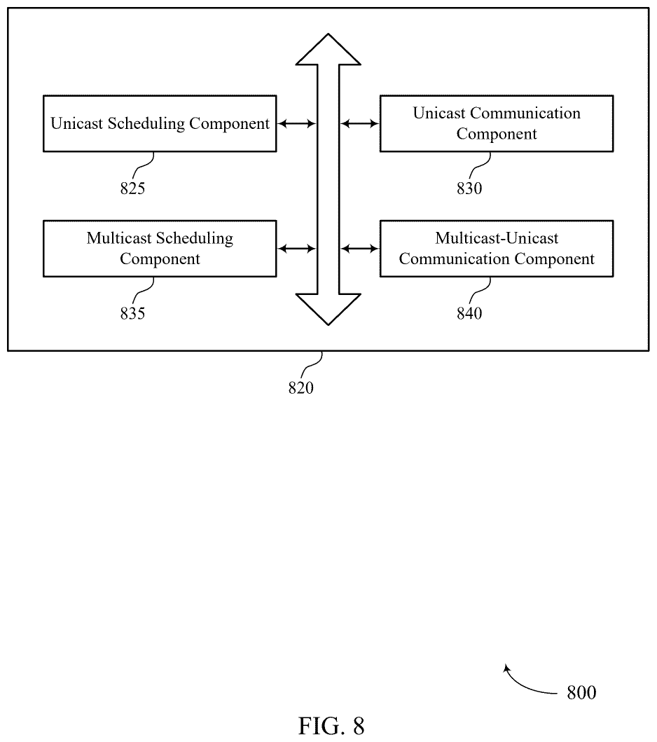

FIG. 8 shows a block diagram 800 of a communications manager 820 that supports power efficient scheduling for multicast and unicast communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of power efficient scheduling for multicast and unicast communications as described herein. For example, the communications manager 820 may include a unicast scheduling component 825, a unicast communication component 830, a multicast scheduling component 835, a multicast-unicast communication component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The unicast scheduling component 825 is capable of, configured to, or operable to support a means for receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The unicast communication component 830 is capable of, configured to, or operable to support a means for receiving, during a first time period, one or more first unicast shared channel messages via the first set of time and frequency resources and in accordance with the first scheduling configuration. The multicast scheduling component 835 is capable of, configured to, or operable to support a means for receiving second control information associated with multicast scheduling of the UE via a second set of time and frequency resources. The multicast-unicast communication component 840 is capable of, configured to, or operable to support a means for receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

In some examples, a baseband of the UE is in a first baseband state associated with a first level of power consumption during the first time period, and whether the UE is restricted to the first scheduling configuration during the second time period is in accordance with whether the UE maintains the baseband of the UE in the first baseband state or switches the baseband of the UE to a second baseband state associated with a second level of power consumption that is higher than the first level of power consumption.

In some examples, the second baseband state supports communications by the UE in accordance with a throughput that is higher than the first maximum throughput, a processing timeline that is shorter than the first minimum processing timeline, an absence of scheduling gaps between consecutive shared channel messages, or any combination thereof.

In some examples, the multicast-unicast communication component 840 is capable of, configured to, or operable to support a means for switching the baseband of the UE to the second baseband state in response to receipt of the second control information associated with the multicast scheduling, where the UE not being restricted to the first scheduling configuration during the second time period in accordance with the second control information includes the baseband of the UE being in the second baseband state during the second time period in response to receipt of the second control information.

In some examples, the second control information associated with the multicast scheduling of the UE includes a CFR configuration associated with the multicast scheduling of the UE. In some examples, the second control information associated with the multicast scheduling of the UE includes an MBS-SSS associated with group-common DCI. In some examples, the second control information associated with the multicast scheduling of the UE includes a group-common DCI message that is decodable by the UE.

In some examples, the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

In some examples, the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

In some examples, the first set of time and frequency resources includes a first BWP. In some examples, the second set of time and frequency resources includes a CFR that at least partially overlaps the first BWP and a second BWP. In some examples, in accordance with the first set of time and frequency resources being associated with the first scheduling configuration, the second control information associated with the multicast scheduling is also associated with the first scheduling configuration.

In some examples, the first set of time and frequency resources includes a first BWP. In some examples, the second set of time and frequency resources includes a CFR that at least partially overlaps the first BWP and a second BWP. In some examples, in accordance with the CFR being associated with the first scheduling configuration, the first set of time and frequency resources remains associated with the first scheduling configuration.

In some examples, the first set of time and frequency resources includes a first BWP. In some examples, the second set of time and frequency resources includes a CFR that at least partially overlaps the first BWP and a second BWP. In some examples, the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof.

In some examples, in accordance with the UE being restricted to the first scheduling configuration during the second time period, the second control information includes a group-common DCI message that indicates a processing timeline for a multicast data message that is longer than or equal to the first minimum processing timeline. In some examples, the processing timeline for the multicast data message is from among a first set of processing timelines that are each longer than or equal to the first minimum processing timeline. In some examples, a second set of processing timelines associated with a second scheduling configuration includes at least one processing timeline that is shorter than the first minimum processing timeline.

In some examples, the processing timeline for the multicast data message is from among a first set of processing timelines that are each longer than or equal to the first minimum processing timeline. In some examples, the unicast scheduling is associated a second set of processing timelines that are each longer than or equal to the first minimum processing timeline, the second set of processing timelines being different from the first set of processing timelines. In some examples, to indicate the processing timeline for the multicast data message, the group-common DCI message indicates an offset relative to a base processing timeline that is shorter than the first minimum processing timeline. In some examples, the second control information indicates a second duration of scheduling gaps between consecutive multicast shared channel messages for the UE that is different than a first duration of the scheduling gaps between the consecutive unicast shared channel messages for the UE.

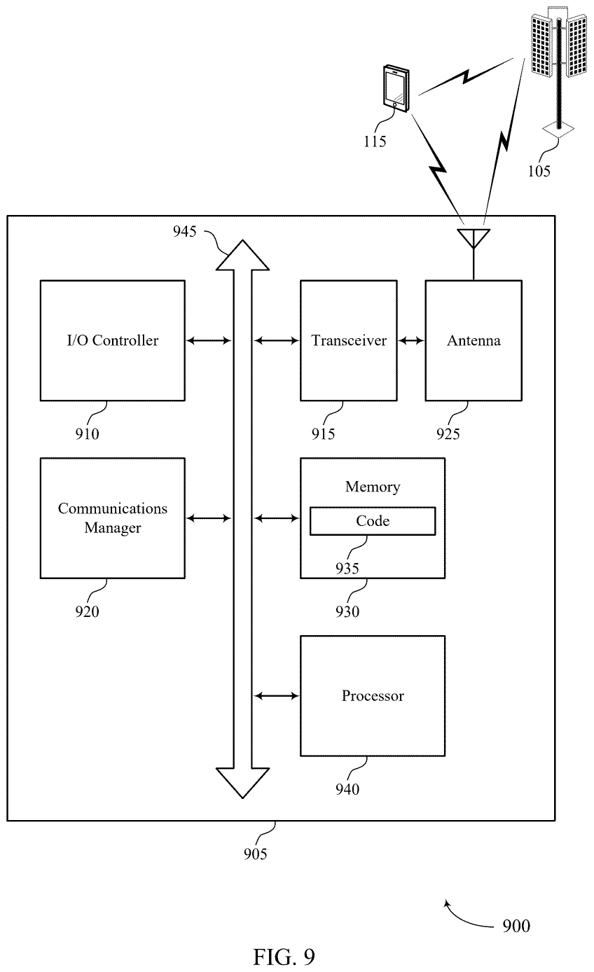

FIG. 9 shows a diagram of a system 900 including a device 905 that supports power efficient scheduling for multicast and unicast communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting power efficient scheduling for multicast and unicast communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The communications manager 920 is capable of, configured to, or operable to support a means for receiving, during a first time period, one or more first unicast shared channel messages via the first set of time and frequency resources and in accordance with the first scheduling configuration. The communications manager 920 is capable of, configured to, or operable to support a means for receiving second control information associated with multicast scheduling of the UE via a second set of time and frequency resources. The communications manager 920 is capable of, configured to, or operable to support a means for receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, improved UE baseband function, and improved unicast and multicast scheduling.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of power efficient scheduling for multicast and unicast communications as described herein, or the at least one processor 940 and the at least one memory 930 may be otherwise configured to, individually or collectively, perform or support such operations.

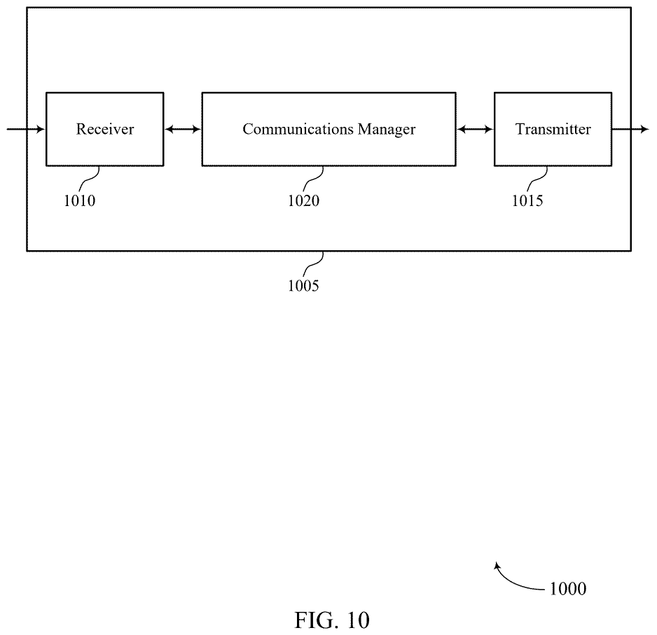

FIG. 10 shows a block diagram 1000 of a device 1005 that supports power efficient scheduling for multicast and unicast communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of power efficient scheduling for multicast and unicast communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The communications manager 1020 is capable of, configured to, or operable to support a means for outputting, to the UE during a first time period, one or more first unicast shared channel messages via the first set of time and frequency resources and in accordance with the first scheduling configuration. The communications manager 1020 is capable of, configured to, or operable to support a means for outputting second control information associated with multicast scheduling of the UE via a second set of time and frequency resources. The communications manager 1020 is capable of, configured to, or operable to support a means for outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources

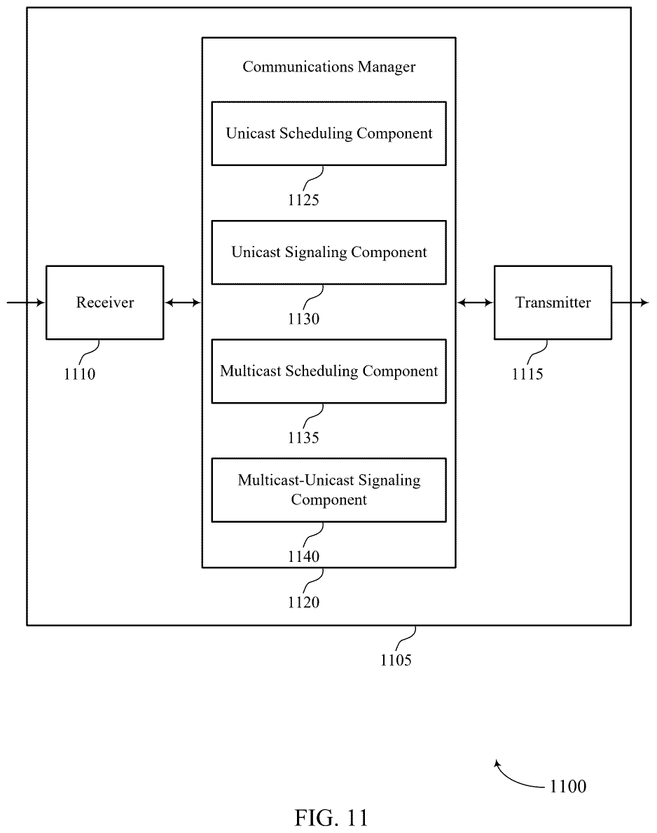

FIG. 11 shows a block diagram 1100 of a device 1105 that supports power efficient scheduling for multicast and unicast communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of power efficient scheduling for multicast and unicast communications as described herein. For example, the communications manager 1120 may include a unicast scheduling component 1125, a unicast signaling component 1130, a multicast scheduling component 1135, a multicast-unicast signaling component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The unicast scheduling component 1125 is capable of, configured to, or operable to support a means for outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The unicast signaling component 1130 is capable of, configured to, or operable to support a means for outputting, to the UE during a first time period, one or more first unicast shared channel messages via the first set of time and frequency resources and in accordance with the first scheduling configuration. The multicast scheduling component 1135 is capable of, configured to, or operable to support a means for outputting second control information associated with multicast scheduling of the UE via a second set of time and frequency resources. The multicast-unicast signaling component 1140 is capable of, configured to, or operable to support a means for outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

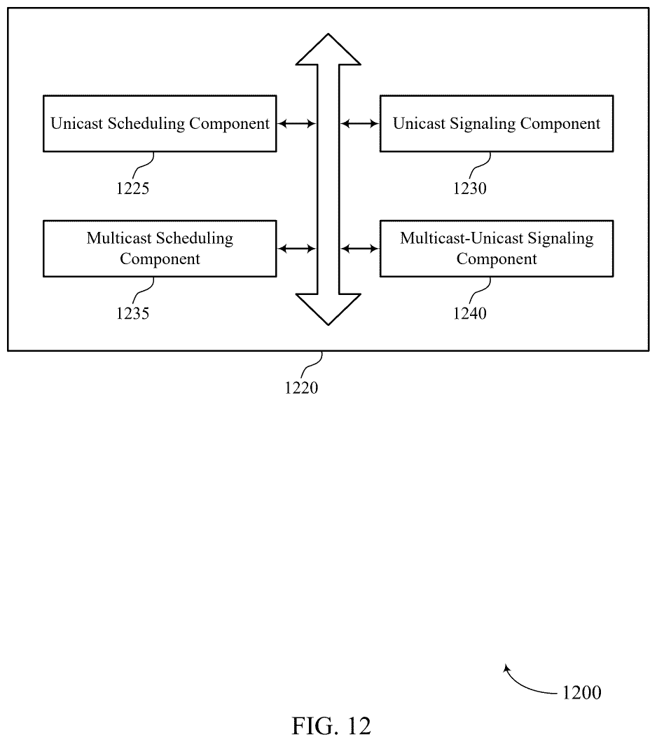

FIG. 12 shows a block diagram 1200 of a communications manager 1220 that supports power efficient scheduling for multicast and unicast communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of power efficient scheduling for multicast and unicast communications as described herein. For example, the communications manager 1220 may include a unicast scheduling component 1225, a unicast signaling component 1230, a multicast scheduling component 1235, a multicast-unicast signaling component 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The unicast scheduling component 1225 is capable of, configured to, or operable to support a means for outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The unicast signaling component 1230 is capable of, configured to, or operable to support a means for outputting, to the UE during a first time period, one or more first unicast shared channel messages via the first set of time and frequency resources and in accordance with the first scheduling configuration. The multicast scheduling component 1235 is capable of, configured to, or operable to support a means for outputting second control information associated with multicast scheduling of the UE via a second set of time and frequency resources. The multicast-unicast signaling component 1240 is capable of, configured to, or operable to support a means for outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

In some examples, a second scheduling configuration supports communications in accordance with a throughput that is higher than the first maximum throughput, a processing timeline that is shorter than the first minimum processing timeline, an absence of scheduling gaps between consecutive shared channel messages, or any combination thereof. In some examples, the UE is not restricted to the first scheduling configuration during the second time period in accordance with the second control information associated with multicast scheduling of the UE being output. In some examples, the second control information associated with the multicast scheduling of the UE includes a CFR configuration associated with the multicast scheduling of the UE, an MBS-SSS associated with group-common DCI, or a group-common DCI message that is decodable by the UE.

In some examples, the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

In some examples, the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

In some examples, the first set of time and frequency resources includes a first BWP. In some examples, the second set of time and frequency resources includes a CFR that at least partially overlaps the first BWP and a second BWP. In some examples, in accordance with the first set of time and frequency resources being associated with the first scheduling configuration, the second control information associated with the multicast scheduling is also associated with the first scheduling configuration.

In some examples, the first set of time and frequency resources includes a first BWP. In some examples, the second set of time and frequency resources includes a CFR that at least partially overlaps the first BWP and a second BWP. In some examples, in accordance with the CFR being associated with the first scheduling configuration, the first set of time and frequency resources remains associated with the first scheduling configuration.

In some examples, the first set of time and frequency resources includes a first BWP. In some examples, the second set of time and frequency resources includes a CFR that at least partially overlaps the first BWP and a second BWP. In some examples, the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof. In some examples, in accordance with the UE being restricted to the first scheduling configuration during the second time period, the second control information includes a group-common DCI message that indicates a processing timeline for a multicast data message that is longer than or equal to the first minimum processing timeline. In some examples, to indicate the processing timeline for the multicast data message, the group-common DCI message indicates an offset relative to a base processing timeline that is shorter than the first minimum processing timeline.

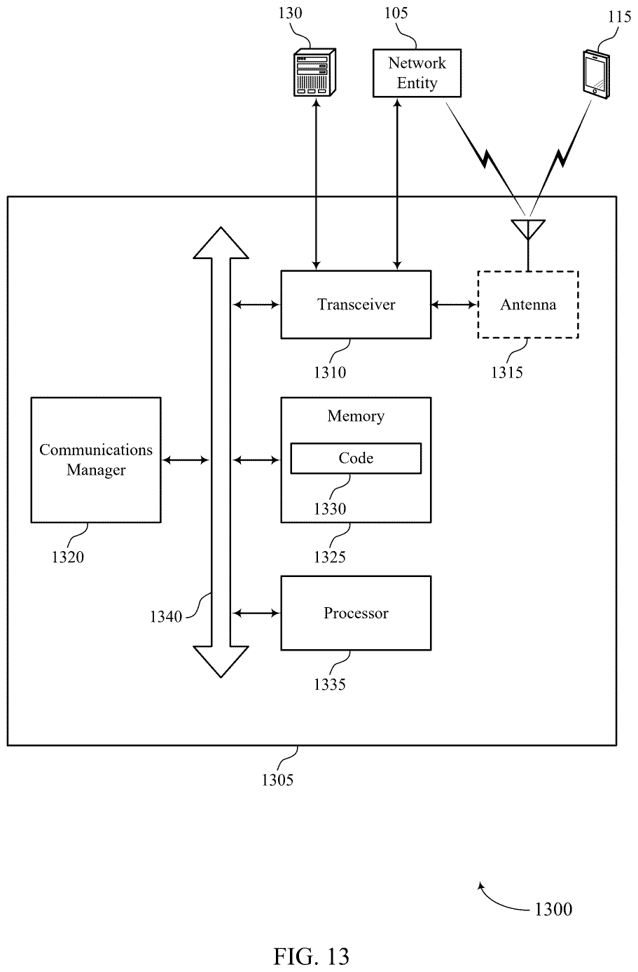

FIG. 13 shows a diagram of a system 1300 including a device 1305 that supports power efficient scheduling for multicast and unicast communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting power efficient scheduling for multicast and unicast communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The communications manager 1320 is capable of, configured to, or operable to support a means for outputting, to the UE during a first time period, one or more first unicast shared channel messages via the first set of time and frequency resources and in accordance with the first scheduling configuration. The communications manager 1320 is capable of, configured to, or operable to support a means for outputting second control information associated with multicast scheduling of the UE via a second set of time and frequency resources. The communications manager 1320 is capable of, configured to, or operable to support a means for outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, improved UE baseband function, and improved unicast and multicast scheduling.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of power efficient scheduling for multicast and unicast communications as described herein, or the at least one processor 1335 and the at least one memory 1325 may be otherwise configured to, individually or collectively, perform or support such operations.

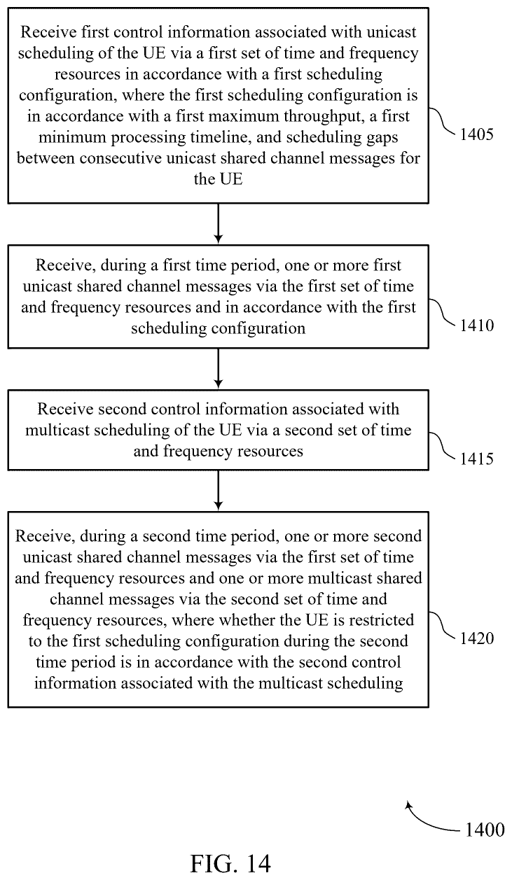

FIG. 14 shows a flowchart illustrating a method 1400 that supports power efficient scheduling for multicast and unicast communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control information associated with unicast scheduling of the UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The operations of 1405 may be performed in accordance with examples as disclosed herein. In some examples, aspects of the operations of 1405 may be performed by a unicast scheduling component 825 as described with reference to FIG. 8.

At 1410, the method may include receiving, during a first time period, one or more first unicast shared channel messages via the first set of time and frequency resources and in accordance with the first scheduling configuration. The operations of 1410 may be performed in accordance with examples as disclosed herein. In some examples, aspects of the operations of 1410 may be performed by a unicast communication component 830 as described with reference to FIG. 8.

At 1415, the method may include receiving second control information associated with multicast scheduling of the UE via a second set of time and frequency resources. The operations of 1415 may be performed in accordance with examples as disclosed herein. In some examples, aspects of the operations of 1415 may be performed by a multicast scheduling component 835 as described with reference to FIG. 8.

At 1420, the method may include receiving, during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling. The operations of 1420 may be performed in accordance with examples as disclosed herein. In some examples, aspects of the operations of 1420 may be performed by a multicast-unicast communication component 840 as described with reference to FIG. 8.

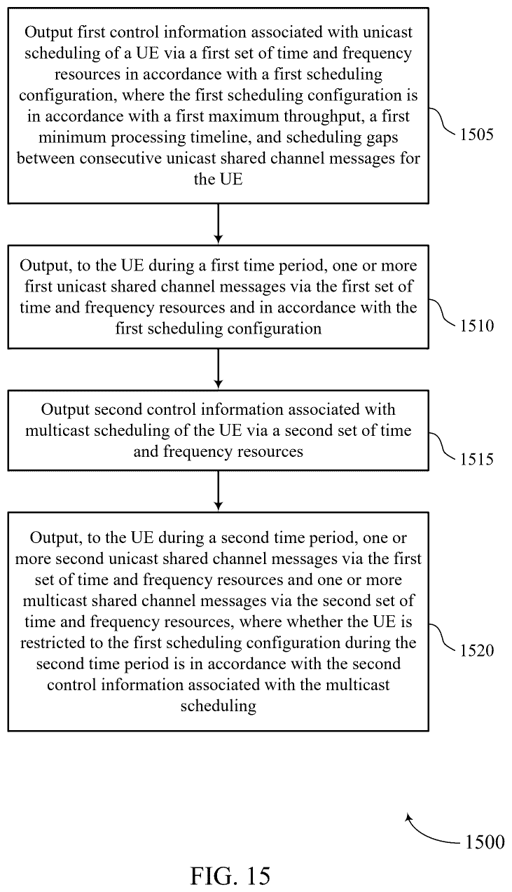

FIG. 15 shows a flowchart illustrating a method 1500 that supports power efficient scheduling for multicast and unicast communications in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting first control information associated with unicast scheduling of a UE via a first set of time and frequency resources in accordance with a first scheduling configuration, where the first scheduling configuration is in accordance with a first maximum throughput, a first minimum processing timeline, and scheduling gaps between consecutive unicast shared channel messages for the UE. The operations of 1505 may be performed in accordance with examples as disclosed herein. In some examples, aspects of the operations of 1505 may be performed by a unicast scheduling component 1225 as described with reference to FIG. 12.

At 1510, the method may include outputting, to the UE during a first time period, one or more first unicast shared channel messages via the first set of time and frequency resources and in accordance with the first scheduling configuration. The operations of 1510 may be performed in accordance with examples as disclosed herein. In some examples, aspects of the operations of 1510 may be performed by a unicast signaling component 1230 as described with reference to FIG. 12.

At 1515, the method may include outputting second control information associated with multicast scheduling of the UE via a second set of time and frequency resources. The operations of 1515 may be performed in accordance with examples as disclosed herein. In some examples, aspects of the operations of 1515 may be performed by a multicast scheduling component 1235 as described with reference to FIG. 12.

At 1520, the method may include outputting, to the UE during a second time period, one or more second unicast shared channel messages via the first set of time and frequency resources and one or more multicast shared channel messages via the second set of time and frequency resources, where whether the UE is restricted to the first scheduling configuration during the second time period is in accordance with the second control information associated with the multicast scheduling. The operations of 1520 may be performed in accordance with examples as disclosed herein. In some examples, aspects of the operations of 1520 may be performed by a multicast-unicast signaling component 1240 as described with reference to FIG. 12.

The following provides an overview of aspects of the present disclosure:

Aspect 1: A method for wireless communications at a UE, comprising: receiving first control information associated with unicast scheduling of the UE via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE; receiving, during a first time period, one or more first unicast shared channel messages via the first set of time and frequency resources and in accordance with the first scheduling configuration; receiving second control information associated with multicast scheduling of the UE via a second set of time and frequency resources; and receiving, during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.

Aspect 2: The method of aspect 1, wherein a baseband of the UE is in a first baseband state associated with a first level of power consumption during the first time period, and whether the UE is restricted to the first scheduling configuration during the second time period is in accordance with whether the UE maintains the baseband of the UE in the first baseband state or switches the baseband of the UE to a second baseband state associated with a second level of power consumption that is higher than the first level of power consumption.

Aspect 3: The method of aspect 2, wherein the second baseband state supports communications by the UE in accordance with a throughput that is higher than the first maximum throughput, a processing timeline that is shorter than the first minimum processing timeline, an absence of scheduling gaps between consecutive shared channel messages, or any combination thereof.

Aspect 4: The method of any of aspects 2 through 3, further comprising: switching the baseband of the UE to the second baseband state in response to receipt of the second control information associated with the multicast scheduling, wherein the UE not being restricted to the first scheduling configuration during the second time period in accordance with the second control information comprises the baseband of the UE being in the second baseband state during the second time period in response to receipt of the second control information.

Aspect 5: The method of aspect 4, wherein the second control information associated with the multicast scheduling of the UE comprises a CFR configuration associated with the multicast scheduling of the UE.

Aspect 6: The method of any of aspects 4 through 5, wherein the second control information associated with the multicast scheduling of the UE comprises a multicast broadcast service MBS-SSS associated with GC-DCI.

Aspect 7: The method of any of aspects 4 through 6, wherein the second control information associated with the multicast scheduling of the UE comprises a GC-DCI message that is decodable by the UE.

Aspect 8: The method of any of aspects 1 through 7, wherein the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

Aspect 9: The method of any of aspects 1 through 8, wherein the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

Aspect 10: The method of any of aspects 1 through 9, wherein the first set of time and frequency resources comprises a first BWP, the second set of time and frequency resources comprises a CFR that at least partially overlaps the first BWP and a second BWP, and in accordance with the first set of time and frequency resources being associated with the first scheduling configuration, the second control information associated with the multicast scheduling is also associated with the first scheduling configuration.

Aspect 11: The method of any of aspects 1 through 10, wherein the first set of time and frequency resources comprises a first BWP, the second set of time and frequency resources comprises a CFR that at least partially overlaps the first BWP and a second BWP, and in accordance with the CFR being associated with the first scheduling configuration, the first set of time and frequency resources remains associated with the first scheduling configuration.

Aspect 12: The method of any of aspects 1 through 11, wherein the first set of time and frequency resources comprises a first BWP, the second set of time and frequency resources comprises a CFR that at least partially overlaps the first BWP and a second BWP, and the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof.

Aspect 13: The method of any of aspects 1 through 12, wherein, in accordance with the UE being restricted to the first scheduling configuration during the second time period, the second control information comprises a GC-DCI message that indicates a processing timeline for a multicast data message that is longer than or equal to the first minimum processing timeline.

Aspect 14: The method of aspect 13, wherein the processing timeline for the multicast data message is from among a first set of processing timelines that are each longer than or equal to the first minimum processing timeline, a second set of processing timelines associated with a second scheduling configuration comprises at least one processing timeline that is shorter than the first minimum processing timeline.

Aspect 15: The method of any of aspects 13 through 14, wherein the processing timeline for the multicast data message is from among a first set of processing timelines that are each longer than or equal to the first minimum processing timeline, the unicast scheduling is associated a second set of processing timelines that are each longer than or equal to the first minimum processing timeline, the second set of processing timelines being different from the first set of processing timelines.

Aspect 16: The method of any of aspects 13 through 15, wherein, to indicate the processing timeline for the multicast data message, the GC-DCI message indicates an offset relative to a base processing timeline that is shorter than the first minimum processing timeline.

Aspect 17: The method of any of aspects 1 through 16, wherein the second control information indicates a second duration of scheduling gaps between consecutive multicast shared channel messages for the UE that is different than a first duration of the scheduling gaps between the consecutive unicast shared channel messages for the UE.

Aspect 18: A method for wireless communications at a network entity, comprising: outputting first control information associated with unicast scheduling of a UE via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE; outputting, to the UE during a first time period, one or more first unicast shared channel messages via the first set of time and frequency resources and in accordance with the first scheduling configuration; outputting second control information associated with multicast scheduling of the UE via a second set of time and frequency resources; and outputting, to the UE during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.

Aspect 19: The method of aspect 18, wherein a second scheduling configuration supports communications in accordance with a throughput that is higher than the first maximum throughput, a processing timeline that is shorter than the first minimum processing timeline, an absence of scheduling gaps between consecutive shared channel messages, or any combination thereof.

Aspect 20: The method of any of aspects 18 through 19, wherein the UE is not restricted to the first scheduling configuration during the second time period in accordance with the second control information associated with multicast scheduling of the UE being output.

Aspect 21: The method of aspect 20, wherein the second control information associated with the multicast scheduling of the UE comprises a CFR configuration associated with the multicast scheduling of the UE, a MBS-SSS associated with GC-DCI, or a GC-DCI message that is decodable by the UE.

Aspect 22: The method of any of aspects 18 through 21, wherein the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

Aspect 23: The method of any of aspects 18 through 22, wherein the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

Aspect 24: The method of any of aspects 18 through 23, wherein the first set of time and frequency resources comprises a first BWP, the second set of time and frequency resources comprises a CFR that at least partially overlaps the first BWP and a second BWP, and in accordance with the first set of time and frequency resources being associated with the first scheduling configuration, the second control information associated with the multicast scheduling is also associated with the first scheduling configuration.

Aspect 25: The method of any of aspects 18 through 24, wherein the first set of time and frequency resources comprises a first BWP, the second set of time and frequency resources comprises a CFR that at least partially overlaps the first BWP and a second BWP, and in accordance with the CFR being associated with the first scheduling configuration, the first set of time and frequency resources remains associated with the first scheduling configuration.

Aspect 26: The method of any of aspects 18 through 25, wherein the first set of time and frequency resources comprises a first BWP, the second set of time and frequency resources comprises a CFR that at least partially overlaps the first BWP and a second BWP, and the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof.

Aspect 27: The method of any of aspects 18 through 26, wherein, in accordance with the UE being restricted to the first scheduling configuration during the second time period, the second control information comprises a GC-DCI message that indicates a processing timeline for a multicast data message that is longer than or equal to the first minimum processing timeline.

Aspect 28: The method of aspect 27, wherein, to indicate the processing timeline for the multicast data message, the GC-DCI message indicates an offset relative to a base processing timeline that is shorter than the first minimum processing timeline.

Aspect 29: A UE for wireless communications, comprising one or more memories storing processor-executable code, and one or more processors coupled with the one or more memories and individually or collectively operable to execute the code to cause the UE to perform a method of any of aspects 1 through 17.

Aspect 30: A UE for wireless communications, comprising at least one means for performing a method of any of aspects 1 through 17.

Aspect 31: A non-transitory computer-readable medium storing code for wireless communications, the code comprising instructions executable by one or more processors to perform a method of any of aspects 1 through 17.

Aspect 32: A network entity for wireless communications, comprising one or more memories storing processor-executable code, and one or more processors coupled with the one or more memories and individually or collectively operable to execute the code to cause the network entity to perform a method of any of aspects 18 through 28.

Aspect 33: A network entity for wireless communications, comprising at least one means for performing a method of any of aspects 18 through 28.

Aspect 34: A non-transitory computer-readable medium storing code for wireless communications, the code comprising instructions executable by one or more processors to perform a method of any of aspects 18 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control information associated with unicast scheduling of the UE via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE;
receive, during a first time period, one or more first unicast shared channel messages via the first set of time and frequency resources and in accordance with the first scheduling configuration;
receive second control information associated with multicast scheduling of the UE via a second set of time and frequency resources; and
receive, during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.

2. The UE of claim 1, wherein:
the one or more processors are individually or collectively further operable to execute the code to cause a baseband of the UE to be in a first baseband state associated with a first level of power consumption during the first time period; and
whether the UE is restricted to the first scheduling configuration during the second time period is in accordance with whether the UE maintains the baseband of the UE in the first baseband state or switches the baseband of the UE to a second baseband state associated with a second level of power consumption that is higher than the first level of power consumption.

3. The UE of claim 2, wherein the second baseband state supports communications by the UE in accordance with a throughput that is higher than the first maximum throughput, a processing timeline that is shorter than the first minimum processing timeline, an absence of scheduling gaps between consecutive shared channel messages, or any combination thereof.

4. The UE of claim 2, wherein the one or more processors are individually or collectively further operable to execute the code to cause the UE to:
switch the baseband of the UE to the second baseband state in response to receipt of the second control information associated with the multicast scheduling, wherein the UE not being restricted to the first scheduling configuration during the second time period in accordance with the second control information comprises the baseband of the UE being in the second baseband state during the second time period in response to receipt of the second control information.

5. The UE of claim 4, wherein the second control information associated with the multicast scheduling of the UE comprises a common frequency resource (CFR) configuration associated with the multicast scheduling of the UE.

6. The UE of claim 4, wherein the second control information associated with the multicast scheduling of the UE comprises a multicast broadcast service (MBS) search space set (SSS) associated with group-common downlink control information (DCI).

7. The UE of claim 4, wherein the second control information associated with the multicast scheduling of the UE comprises a group-common downlink control information (DCI) message that is decodable by the UE.

8. The UE of claim 1, wherein the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

9. The UE of claim 1, wherein the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

10. The UE of claim 1, wherein the first set of time and frequency resources comprises a first bandwidth part, wherein the second set of time and frequency resources comprises a common frequency resource (CFR) that at least partially overlaps the first bandwidth part and a second bandwidth part, and wherein, in accordance with the first set of time and frequency resources being associated with the first scheduling configuration, the second control information associated with the multicast scheduling is also associated with the first scheduling configuration.

11. The UE of claim 1, wherein the first set of time and frequency resources comprises a first bandwidth part, wherein the second set of time and frequency resources comprises a common frequency resource (CFR) that at least partially overlaps the first bandwidth part and a second bandwidth part, and wherein, in accordance with the CFR being associated with the first scheduling configuration, the first set of time and frequency resources remains associated with the first scheduling configuration.

12. The UE of claim 1, wherein the first set of time and frequency resources comprises a first bandwidth part, wherein, the second set of time and frequency resources comprises a common frequency resource (CFR) that at least partially overlaps the first bandwidth part and a second bandwidth part, and wherein, the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof.

13. The UE of claim 1, wherein, in accordance with the UE being restricted to the first scheduling configuration during the second time period, the second control information comprises a group-common downlink control information (DCI) message that indicates a processing timeline for a multicast data message that is longer than or equal to the first minimum processing timeline.

14. The UE of claim 13, wherein the processing timeline for the multicast data message is from among a first set of processing timelines that are each longer than or equal to the first minimum processing timeline, wherein a second set of processing timelines associated with a second scheduling configuration comprises at least one processing timeline that is shorter than the first minimum processing timeline.

15. The UE of claim 13, wherein the processing timeline for the multicast data message is from among a first set of processing timelines that are each longer than or equal to the first minimum processing timeline, wherein the unicast scheduling is associated a second set of processing timelines that are each longer than or equal to the first minimum processing timeline, the second set of processing timelines being different from the first set of processing timelines.

16. The UE of claim 13, wherein, to indicate the processing timeline for the multicast data message, the group-common DCI message indicates an offset relative to a base processing timeline that is shorter than the first minimum processing timeline.

17. The UE of claim 1, wherein the second control information indicates a second duration of scheduling gaps between consecutive multicast shared channel messages for the UE that is different than a first duration of the scheduling gaps between the consecutive unicast shared channel messages for the UE.

18. A network entity, comprising:
one or more memories storing processor-executable code; and
one or more processors coupled with the one or more memories and individually or collectively operable to execute the code to cause the network entity to:
output first control information associated with unicast scheduling of a user equipment (UE) via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE;
output, to the UE during a first time period, one or more first unicast shared channel messages via the first set of time and frequency resources and in accordance with the first scheduling configuration;
output second control information associated with multicast scheduling of the UE via a second set of time and frequency resources; and
output, to the UE during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.

19. The network entity of claim 18, wherein a second scheduling configuration supports communications in accordance with a throughput that is higher than the first maximum throughput, a processing timeline that is shorter than the first minimum processing timeline, an absence of scheduling gaps between consecutive shared channel messages, or any combination thereof.

20. The network entity of claim 18, wherein the UE is not restricted to the first scheduling configuration during the second time period in accordance with the second control information associated with multicast scheduling of the UE being output.

21. The network entity of claim 20, wherein the second control information associated with the multicast scheduling of the UE comprises a common frequency resource (CFR) configuration associated with the multicast scheduling of the UE, a multicast broadcast service (MBS) search space set (SSS) associated with group-common downlink control information (DCI), or a group-common DCI message that is decodable by the UE.

22. The network entity of claim 18, wherein the UE is restricted to the first scheduling configuration during the second time period in accordance with the second set of time and frequency resources spanning less than a threshold bandwidth and the second control information associated with the multicast scheduling indicating a processing timeline that is longer than or equal to the first minimum processing timeline.

23. The network entity of claim 18, wherein the UE is restricted to the first scheduling configuration during the second time period in accordance with the second control information associated with the second set of time and frequency resources spanning greater than a threshold bandwidth and the multicast scheduling indicating a processing timeline that is longer than or equal to the first minimum processing timeline and further indicating a presence of scheduling gaps between consecutive multicast shared channel messages for the UE.

24. The network entity of claim 18, wherein the first set of time and frequency resources comprises a first bandwidth part, wherein the second set of time and frequency resources comprises a common frequency resource (CFR) that at least partially overlaps the first bandwidth part and a second bandwidth part, and wherein, in accordance with the first set of time and frequency resources being associated with the first scheduling configuration, the second control information associated with the multicast scheduling is also associated with the first scheduling configuration.

25. The network entity of claim 18, wherein the first set of time and frequency resources comprises a first bandwidth part, wherein the second set of time and frequency resources comprises a common frequency resource (CFR) that at least partially overlaps the first bandwidth part and a second bandwidth part, and wherein, in accordance with the CFR being associated with the first scheduling configuration, the first set of time and frequency resources remains associated with the first scheduling configuration.

26. The network entity of claim 18, wherein the first set of time and frequency resources comprises a first bandwidth part, wherein the second set of time and frequency resources comprises a common frequency resource (CFR) that at least partially overlaps the first bandwidth part and a second bandwidth part, and wherein the second control information indicates a peak throughput for the multicast scheduling that is less than or equal to the first maximum throughput, a processing timeline for the multicast scheduling that is longer than or equal to the first minimum processing timeline, a duration of a scheduling gap between consecutive multicast shared channel messages for the UE, or any combination thereof.

27. The network entity of claim 18, wherein, in accordance with the UE being restricted to the first scheduling configuration during the second time period, the second control information comprises a group-common downlink control information (DCI) message that indicates a processing timeline for a multicast data message that is longer than or equal to the first minimum processing timeline.

28. The network entity of claim 27, wherein, to indicate the processing timeline for the multicast data message, the group-common DCI message indicates an offset relative to a base processing timeline that is shorter than the first minimum processing timeline.

29. A method for wireless communications at a user equipment (UE), comprising:
receiving first control information associated with unicast scheduling of the UE via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE;
receiving, during a first time period, one or more first unicast shared channel messages via the first set of time and frequency resources and in accordance with the first scheduling configuration;
receiving second control information associated with multicast scheduling of the UE via a second set of time and frequency resources; and
receiving, during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.

30. A method for wireless communications at a network entity, comprising:
outputting first control information associated with unicast scheduling of a user equipment (UE) via a first set of time and frequency resources in accordance with a first scheduling configuration, wherein the first scheduling configuration is in accordance with a first maximum throughput, a first minimum processing timeline, and scheduling gaps between consecutive unicast shared channel messages for the UE;
outputting, to the UE during a first time period, one or more first unicast shared channel messages via the first set of time and frequency resources and in accordance with the first scheduling configuration;
outputting second control information associated with multicast scheduling of the UE via a second set of time and frequency resources; and
outputting, to the UE during a second time period, one or more second unicast shared channel messages via the first set of time and frequency resources and one or more multicast shared channel messages via the second set of time and frequency resources, wherein whether the UE is restricted to the first scheduling configuration during the second time period is in accordance with the second control information associated with the multicast scheduling.
